(19) United States
(12) Patent Application Publication
(10) Pub. No.: US 2026/0001457 A1
(43) Pub. Date: Jan. 1, 2026

(54) FASTENERS AND METHODS OF FASTENING FOAMLESS CUSHIONS

(71) Applicant: LEAR CORPORATION, Southfield, MI (US)

(72) Inventors: David HALE, Southfield, MI (US); Christopher JOHNSON, Southfield, MI (US); Ibrahim VALENZUELA, Novi, MI (US)

(73) Assignee: LEAR CORPORATION, Southfield, MI (US)

(21) Appl. No.: 19/127,009

(22) PCT Filed: Oct. 13, 2023
(86) PCT No.: PCT/US2023/035142

§ 371 Date: May 2, 2025

Related U.S. Application Data
(60) Provisional application No. 63/422,708, filed on Nov. 4, 2022.

(30) Foreign Application Priority Data
Aug. 16, 2023 (DK) PA202370420

(51) Int. Cl. B60N 2/58

(52) U.S. Cl. CPC B60N 2/5825

(57) ABSTRACT

Fasteners to couple foamless cushions of intertwined or entangled polymeric strands and methods thereof. In a first embodiment of the fastener, it comprises a retainer portion that anchors the fastener in the polymeric strands of the cushions and a protruding portion that extends through the polymeric strands of the cushion to another fastener. The retainer portion may have a larger dimension, area, or cross-section area than the retainer portion such that it is inhibited from penetrating through the polymeric strands.

### CROSS-REFERENCE TO RELATED CASES

This application claims the benefit of U.S. Provisional Patent Application No. 63/422,708 filed on Nov. 4, 2022 as well as priority of Denmark Patent Application No. PA 2023 70420 filed on Aug. 16, 2023, the disclosures of which are hereby incorporated by reference in their entirety.

### TECHNICAL FIELD

The instant disclosure relates to cushion assemblies, fasteners for securing cushions, and methods of fastening cushions. More specifically, foamless cushion assemblies of intertwined polymeric strands and fasteners for the same are disclosed.

### BRIEF DESCRIPTION OF THE DRAWINGS

FIG. 1 is a perspective partial cross-sectional view of an embodiment of a seat assembly.

FIG. 2 is a front view of a first and second foamless or non-foam cushion with first and second fasteners disposed therein.

FIG. 3 is a front view of the first and second fasteners of FIG. 2 coupled together.

FIG. 4 is a zoomed in view of the first and second fasteners coupled together.

FIG. 5 is a perspective view of a schematic of a first and a second cushion with the first and second fasteners disposed therein.

FIG. 6 is a perspective view of the first and second fasteners of FIG. 5 coupled together.

FIG. 7 is a front perspective view of an embodiment of a first fastener.

FIG. 8 is a front perspective view of an embodiment of a second fastener.

FIG. 9 is a front perspective view of an embodiment of a third fastener.

FIG. 10 is a front perspective view of embodiments of fourth and fifth fasteners.

FIG. 11 is a front perspective view of and embodiment of a sixth fastener.

FIG. 12 is a flowchart of a method of assembling a seat assembly.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word about in describing the broadest scope of the invention. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose in connection with the invention implies the mixtures of any two or more of the members of the group or class are equally suitable or preferred. Molecular weights provided for any polymers refers to number average molecular weight. Description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially,” “generally,” or “about” may be used herein to describe disclosed or claimed embodiments. The terms “substantially,” “generally,” or “about” may modify a value or relative characteristic disclosed or claimed in the present disclosure to signify within manufacturing tolerances and/or within ±0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

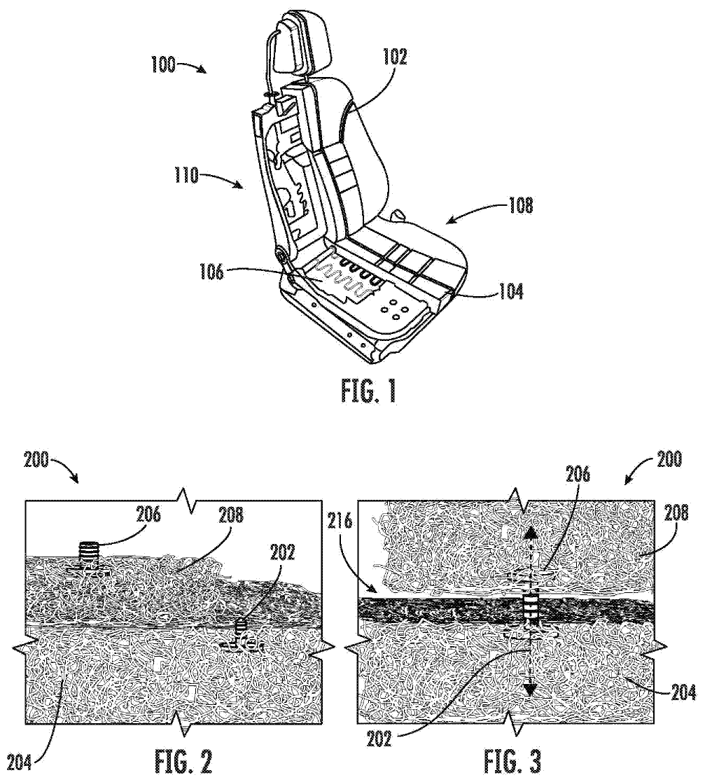

FIG. 1 is a seat assembly 100 such as for a vehicle (e.g., automobile, motorcycle, train, aircraft, watercraft). In one or more embodiments, the seat assembly 100 includes a trim cover 102 disposed over a cushion assembly 104 and a frame 106. In a variation, the frame 106 supports the cushion assembly 104 as well as an occupant. In a refinement, the frame 106 supports other components such as a massaging assembly, a ventilation assembly, a temperature control assembly, a sensor assembly, and/or an electronic assembly. In a refinement, the cushion assembly 106 includes one or more cushions such as a first cushion 108 (e.g., seat bottom) and a second cushion 110 (e.g., seat back).

In one or more embodiments, the trim cover 102 is arranged to contact an occupant. For example, the trim cover 102 is made of leather, faux leather, woven cloth, polyurethane, and/or polyester. In various embodiments, the seat frame 102 is made of a rigid material such as metal, plastic, wood, or a combination thereof. For example, a steel and/or aluminum seat frame 106 is used.

In various embodiments, unlike conventional cushions which are generally molded foams, one or more of the cushions is foamless or comprised of a non-foam material such as a plurality of entangled and/or intertwined polymeric strands defining one or more cushion bodies as depicted in FIGS. 2-4. In other words, portions of the various polymeric strands are entangled with portions of other polymeric strands such that the plurality of polymeric strands serves as a single unit, piece, cushion, pillow, pad, or mat. In a variation, the polymeric strands are any suitable polymeric material such as a thermoplastic polymer (e.g., polyolefins, polyethylene, polypropylene, polystyrene, polycarbonate, and/or polyvinyl chloride). For example, the polymeric strands may be low-or high-density polyethylene. Hereinafter, this cushion may merely be referred to as a non-foam or foamless cushion. The application identified by Ser. No. 17/741,639 filed on May 11, 2022, further describes non-foam or foamless cushions and is hereby incorporated by reference in its entirety. The term cushion is used herein, however it should be understood that the non-foam or foamless bodies of polymeric strands may also be referred to as pads or pillows.

The structure of non-foam or foamless cushions may be difficult to secure with traditional fasteners designed to fasten, for example, foams. Accordingly, in one or more embodiments, the cushion assembly 200 includes one or more fasteners, as shown in FIGS. 2-11. In a refinement, the one or more fasteners fasten the one or more cushions into position and/or couple the cushions together. For example, the cushion assembly 200 includes a first (e.g., male) fastener 202 disposed in a first cushion 204 and a second (e.g., female) fastener 206 disposed in a second cushion 208. In various embodiments, the cushions or cushion bodies each have a side defining a surface or surface portion and have a slot below the surface or surface portion. For example, the first cushion 204 includes a first side (e.g., top) defining a first surface (e.g., top surface) with a first slot 210 below the first surface and the second cushion 208 includes a second side (e.g., bottom) defining a second surface (e.g., bottom surface) with a second slot 212 below the second surface. In one or more embodiments, the first and/or second slots 210, 212 are cut into the cushions after extrusion. Alternatively, the slots may be defined by a breaker plate die during extrusion. The surfaces or surface portions described herein are relative to the cushion body formed by the polymeric strands and not the individual polymeric strands. For example, the first cushion 204, as shown in FIG. 2, illustrates a first surface 214 corresponding to a first surface plane defined by the axes X and Y. Although the cushions are depicted herein as rectangular or cuboidal, the shape and size of the cushions are not particularly limited in their shape or size and the surface is not limited to a plane. In a refinement, the first and second fasteners are coupled such that the surfaces of the first and second cushions are adjacent one another.

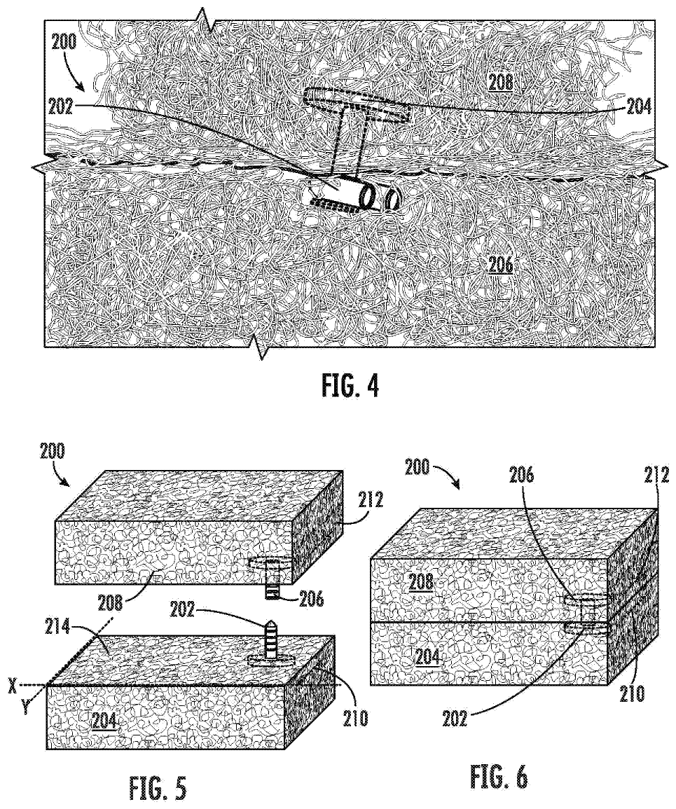

In a variation shown in FIG. 4, the fastener 300 has a retainer or anchor portion 302 that serves to retain or anchor the fastener 300 in the plurality of polymeric strands. In a refinement, the fastener 300 also includes a protruding portion 304 extending from the retainer or anchor portion 302. In various embodiments, the protruding portion 304 is configured to be received by another fastener such as those depicted in FIGS. 8-9 and 11. For example, the protruding portion 304 may include a fastening mechanism 306 such as a screw (i.e., spiral ramp), a clip (e.g., Christmas tree clip), a clasp, a hook, a rivet, a snap, or any other known fastening mechanisms. In one or more embodiments, the fastener 300 is configured to cooperate with a second fastener by coupling together such as depicted in FIGS. 4 and 6.

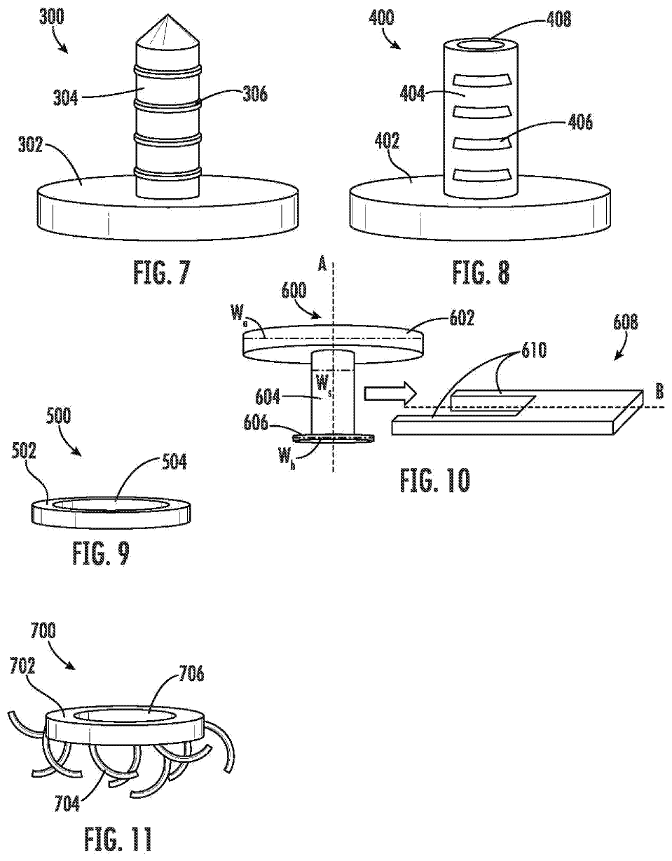

Referring to FIG. 8, for example, a second fastener 400 having a retainer or anchor portion 402 that serves to retain or anchor the second fastener 400, for example, in a second foamless or non-foam cushion. The second fastener 400 is configured to receive the first fastener 300. In various embodiments, the second fastener 400 includes a protruding portion 404 extending from the retainer or anchor portion 402 and the protruding portion 404 includes a fastening mechanism 406 that corresponds with the fastening mechanism 306 of the first fastener 300. For example, the protruding portion 404 of the second fastener 400 may define a cavity 408, i.e., a hollow bin configured to receive the protruding portion 304 of the first fastener 300. In yet another embodiment, as depicted in FIG. 9, the second fastener 500 includes a retainer or anchor portion 502 that defines an orifice 504 configured to receive the first fastener 300. For example, in some embodiments, the protruding portion 304 of the first fastener 500 includes a screw (i.e., spiral ramp) and the second fastener 400/500 is configured to receive the screw. For example, the hollow bin of the second fastener 400 includes a groove corresponding the screw for coupling the first and second fasteners 300, 400. In yet another example, the first fastening mechanism 306 is a Christmas tree clip and the hollow bin of the second fastener 400 includes a one or more apertures for receiving the clip. In a refinement, as shown in FIG. 11, the retainer or anchor portion 702 of the fastener 700 includes a plurality of barbs 704. In other words, any of the embodiments described herein may include a barbed retainer or anchor portion to more securely retain or anchor it in the cushion. For example, the retainer or anchor portion 702 is configured to receive another fastener via an orifice 706 and includes a plurality of barbs 704.

In yet another embodiment, referring to FIG. 10, the fastener 600 includes a retainer or anchor portion 602 and a protruding shaft portion 604 extending therefrom. In a variation, the fastener 600 also includes a head portion 606 disposed on the shaft portion 604 opposite the retainer or anchor portion 602. In a refinement, the head portion 606 has a greater or larger dimension Wₕ (e.g., width) than the dimension Wₛ of the shaft portion. The head portion 606 is configured to inhibit the second fastener from slipping or sliding off the shaft portion. In one or more embodiments, a second fastener 608 is configured to cooperate with the shaft portion 604 such as by coupling (e.g., snapping and/or clipping) onto the shaft portion 604. For example, the first fastener 600 is disposed in a first cushion such that the head portion 606 and shaft portion 604 are protruding through the first cushion into a second cushion. Once protruding into the second cushion the second fastener 608 is clipped onto the shaft portion 604 such that the two cushion are coupled together. In a refinement, the protruding portion of the first fastener 600 defines a first axis A and is coupled to a second fastener 608 such as from a sliding or sideways action along a second axis B defined by the second fastener. In other words, the fasteners may be coupled by engaging them from directions that are not parallel, or are substantially perpendicular (e.g., within ±10 degrees, ±20 degrees, ±30 degrees, or ±45 degrees of being perpendicular).

In various embodiments, the fasteners described herein may be made of any suitable material. For example, the fasteners are comprised of a thermoplastic polymer (e.g., polyolefins, polyethylene, polypropylene, polystyrene, polycarbonate, and/or polyvinyl chloride). In a refinement, the fasteners are low-or high-density polyethylene. In a variation, the fasteners are made of the same polymeric material as the cushion (i.e., polymeric strands) such that they can be recycled with the cushion and there is no need to remove them. In a refinement, the cushions are coupled together without adhesive via the fasteners described herein. In other words, the cushion assembly may be free or substantially free (i.e., less than 1%, 0.5%, or 0.1% by weight) of adhesive.

Referring to FIG. 3, the shape of the retainer or anchor portion is not particularly limited but in various embodiments includes a generally flat section that has a width Wₐ that is two, three, five, or ten times the width Wₛ of, for example, the protruding portion and extends along the width of many polymeric strands such that the polymeric strands sterically inhibit the fastener from moving along a first axis D₁, as shown in FIG. 3. For example, the retainer or anchor portion is circular, rectangular, square-shaped, diamond-shaped, triangular, S-shaped, or any other suitable shape. The shape of the protruding member is not particularly limited. For example, the shape may be cylindrical, hooked shaped, or pointed. In a refinement, protruding portion is a shape and width such that it more easily can be navigated through the plurality of polymeric strands. For example, the protruding portion includes a pointed or rounded tip to more easily penetrate through the strands. In a variation, the protruding portion is of a length such that it extends from the surface of the first cushion, or more preferably extends from the slot through the surface of the first cushion, or even more preferably from the slot, through the first surface of the first cushion and through the second (e.g., adjacent) surface of the second cushion, and still more preferably the protruding portion extends from the first slot of the first cushion, through the first surface of the first cushion, through the second (e.g., adjacent) surface of the second cushion to the second slot of the second cushion. In various embodiments, the retainer or anchor portion has a larger cross-sectional area along the axis B, as shown in FIG. 10, than the protruding shaft portion and the head portion. In a refinement, the head portion has a greater cross-sectional area than the protruding shaft portion.

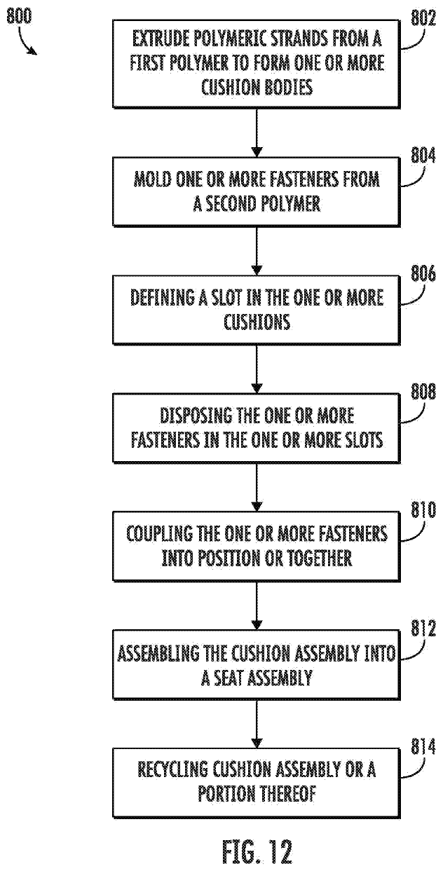

Referring to FIG. 12, a method 800 of producing a cushion assembly is disclosed. The method 800 includes one or more of the following steps: extruding one or more cushion bodies (i.e., step 802), molding one or more fasteners as described herein (i.e., step 804), defining one or more slots in the one or more cushion bodies (i.e., step 806), disposing at least one of the one or more fasteners in the one or more slots (i.e., step 808), coupling the one or more fasteners into position or together (i.e., step 810), and assembling the cushion assembly into a seat assembly such as for a vehicle (i.e., step 812).

In various embodiments, the one or more cushion bodies are foamless or non-foam cushions comprising a plurality of entangled or intertwined polymeric strands as described above. In a refinement, the slots may be cut into the cushions after extruding them. Alternatively, a breaker plate die may be used for that defines a cavity or slot in the cushion during extrusion. In one or more embodiments, the fasteners may be made from the same polymeric material as the cushions. Alternatively, the fasteners and cushions may be made from polymeric materials that can be recycled together without separation. For example, the cushions and fasteners are polymeric materials of different grades or polymeric materials having similar melting points.

In a variation, the fasteners are coupled into position or together by screwing them together, by clipping them together, by snapping them together, or by any other suitable attachment mechanism. For example, a first fastener having a retainer or anchor portion and a protruding portion is disposed in a first cushion such as in a first slot of the first cushion by moving it laterally through the slot in a first direction until it is in the desired or intended position (e.g., a predetermined position) and then extending or pushing the protruding portion through the cushion in a second direction that is different than the first direction until it extends or penetrates through a first surface of the cushion. For example, the first and second directions are perpendicular. In a refinement, the protruding portion is pushed until it penetrates the surface (e.g., a second surface) of a second cushion (e.g., an adjacent cushion) and is coupled to a second fastener disposed in the second cushion such as in a slot of the second cushion.

In one or more embodiments, the second fastener is disposed in the second cushion by moving it laterally along the slot in a third direction that may be the same or substantially similar to the first direction. The second fastener is moved to a position corresponding to the first fastener. In a refinement, the second fastener is moved in a fourth direction (e.g., opposite the second direction) that is different than the third direction to couple it to the first fastener such as to the protruding portion of the first fastener. Alternatively, the second fastener may be moved laterally in the third direction until it is coupled to the first fastener such as by clipping or snapping onto a protruding shaft portion of the first fastener. Accordingly, in some embodiments, the first fastener may be pushed through the surface of the second cushion and through the second cushion until it reaches the slot in the second cushion. In other embodiments, the protruding portion of the first fastener is pushed through the first cushion and a protruding portion of the second fastener is pushed through the second cushion until they meet and are coupled. In various embodiments, the fasteners may be adjustably fastened such as at predetermined increments to adjust the distance between the first retainer or anchor portion and the second retainer or anchor portion. For example, the fasteners may be fastened such that the cushions are touching each other as in FIG. 4. Alternatively, the fasteners may be fastened such that they define a gap 216 as shown FIG. 3.

In one or more embodiments, the cushion assembly or a portion thereof is recycled. As the cushions and fasteners are made of compatible, similar, substantially similar, or the same material there is no need to separate or remove the fasteners before recycling. In a variation, recycling includes shearing the cushion assembly into smaller portions or pieces such as by grinding, smashing, tearing, shredding, and/or milling. In a refinement, the cushion assembly is melted into a polymeric resin such that it can be reused such as, for example, after a specific particle size is achieved or a specific period of shearing. In one or more embodiments, the polymeric resin is filtered, refined, or purified after melting and before reuse. In one or more embodiments, a plurality of cushion assemblies is recycled without removing the fasteners. In still other embodiments, one or more cushion assemblies may be produced from the recycled polymeric resin.

According to a first aspect of the cushion assemblies described herein, the assembly comprises a first body comprising a first plurality of polymeric strands, a first fastener disposed in the first body, a second body comprising a second plurality of polymeric strands and a second fastener configured to cooperate with the first fastener and disposed in the second body. In a variation, the first body comprises a first side defining a first surface and the second body comprises a second side defining a second surface. In a refinement, the first fastener comprises a retainer portion configured to be disposed in the first body and a protruding portion extending or protruding from the retainer portion through the first surface such that the second fastener cooperates with the protruding portion to couple the first and second cushions together.

According to a second aspect, the first body of the first aspect or any of the subsequent aspects defines a first slot disposed below the first surface of the first body and the first fastener is disposed in the first slot.

According to a third aspect, the second body of the any of the preceding or subsequent aspects defines a second slot disposed below the second surface of the second body and the second fastener is disposed in the second slot.

According to a fourth aspect, the protruding portion of any of the preceding or subsequent aspects is configured to extend through the second surface of the second body to the second slot.

According to a fifth aspect, the second fastener of any of the preceding aspects or subsequent aspects is configured to receive the protruding portion of the first fastener.

According to a sixth aspect, the second fastener of any of the preceding or subsequent aspects comprises a retainer portion.

According to a seventh aspect, the first or second fastener of any of the preceding or subsequent aspects is barbed.

According to an eighth aspect, the second fastener of any of the preceding or subsequent aspects comprises a retainer portion and a corresponding protruding portion that extends from the retainer portion of the second fastener through the second surface and is configured to receive the protruding portion of the first fastener.

According to a ninth aspect, the first fastener of any of the preceding or subsequent aspects comprises a shaft portion and a head portion opposite the retainer portion, the head portion comprises a larger dimension than the shaft portion such that the second fastener cooperates with the shaft portion to engage the first and second fasteners together.

According to a tenth aspect, the retainer portion of any of the preceding or subsequent aspects (i.e., of the first and/or second fastener) has a cross-sectional area that is greater than the cross-sectional area of the protruding portion.

According to an eleventh aspect, the fasteners of any of the preceding or subsequent aspects comprise a thermoplastic polymer material.

According to a twelfth aspect, the polymeric strands of any of the preceding or subsequent aspects comprise the same thermoplastic polymer material as the fasteners.

According to a thirteenth aspect, the cushion assembly of any of the preceding or subsequent aspects may be disposed in a vehicle seat assembly and supported by a seat frame.

According to a fourteenth aspect, a cushion assembly comprises a first cushion and first and second fasteners. In a variation, the first cushion comprises a first side defining a first surface and a first slot disposed below the first surface. In a refinement, the first fastener comprises a retainer portion disposed in the first slot and a protruding portion extending or protruding from the retainer portion through the cushion and the first surface and the second fastener is configured to cooperate with the protruding portion of the first fastener.

According to a fifteenth aspect, the cushion assembly of any of the proceeding or subsequent aspects comprises a second cushion such that the second fastener is disposed in the second cushion and the first and second cushions are coupled together when the first and second fasteners are coupled together.

According to a sixteenth aspect, the first and second cushions of any of the preceding or subsequent aspects are coupled together without adhesive.

According to a seventeenth aspect, the second cushion of any of the preceding or subsequent aspects comprises a second side defining a second surface and a second slot disposed below the second surface such that the second fastener is disposed in the second slot.

According to an eighteenth aspect, the first and/or second cushions of any of the preceding or subsequent aspects is a body of polymeric strands.

According to a nineteenth aspect, a method of coupling a cushion comprises disposing a first fastener in a first cushion, disposing a second fastener in a second cushion, and coupling the first and second fasteners together. In a variation, the first fastener comprises a retainer portion and a protruding portion configured to extend through the first cushion and a first surface portion of the first cushion. In a refinement, the second fastener is configured to be coupled to the first fastener and comprises a retainer portion. In one or more embodiments, the first and second fasteners cooperate to couple the first and second cushions together.

According to a twentieth aspect, the first fastener of any of the preceding or subsequent aspects is disposed in a first slot of the first cushion below the first surface portion of the first cushion and the second fastener is disposed in a second slot of the second cushion below a second surface portion of the second cushion.

According to a twenty-first aspect, the method of any of the preceding or subsequent aspects comprises defining a first slot in the first cushion and a second slot in the second cushion.

According to a twenty-second aspect, the first and second slots of any of the preceding or subsequent aspect are defined by cutting the first and second cushions.

According to a twenty-third aspect, the first and second slots of any of the preceding or subsequent aspects are defined by a breaker plate used to extrude the first and second cushions.

According to a twenty-fourth aspect, the method of any of the preceding or subsequent aspects comprises extending the protruding portion through the first surface portion into the second surface portion such that it penetrates the second surface portion and is coupled to the second fastener.

According to a twenty-fifth aspect, the first and/or second cushions of any of the preceding or subsequent aspects comprise a plurality of polymeric strands.

According to a twenty-sixth aspect, the method of any of the preceding or subsequent aspects comprises molding the first and second fasteners from a polymer that is the same as the polymeric strands.

According to twenty-seventh aspect, the method of any of the preceding subsequent aspects comprises recycling the first and/or second cushions without removing the first and/or second fasteners.

According to a twenty-eighth aspect, recycling of any of the preceding or subsequent aspects comprises shearing into smaller pieces and melting to form a polymer resin.

According to a twenty-nineth aspect, the method of any of the preceding or subsequent aspects comprises assembling the first and second cushions on a seat frame of a vehicle seat.

While exemplary embodiments are described above, it is not intended that these embodiments describe all possible forms encompassed by the claims. The words used in the specification are words of description rather than limitation, and it is understood that various changes can be made without departing from the scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1-20. (canceled)

21. A cushion assembly comprising:
a first plurality of polymeric strands defining a first body comprising a first side defining a first surface;
a first fastener comprising a retainer portion disposed in the first body and a protruding portion protruding from the retainer portion through the first surface;
a second plurality of polymeric strands defining a second body comprising a second side defining a second surface; and
a second fastener disposed in the second body and configured to cooperate with the protruding portion such that the first body and the second body are coupled together.

22. The cushion assembly of claim 21, wherein the first body defines a first slot below the first surface and the first fastener is disposed in the first slot.

23. The cushion assembly of claim 22, wherein the second body defines a second slot below the second surface and the second fastener is disposed in the second slot.

24. The cushion assembly of claim 23, wherein the protruding portion is configured to extend through the second surface of the second body to the second slot.

25. The cushion assembly of claim 21, wherein the second fastener is configured to receive the protruding portion of the first fastener.

26. The cushion assembly of claim 21, wherein the second fastener comprises a retainer portion and the retainer portion of the first or second fastener is barbed.

27. The cushion assembly of claim 21, wherein the second fastener comprises a retainer portion and a corresponding protruding portion that extends from the retainer portion of the second fastener through the second surface and is configured to receive the protruding portion of the first fastener.

28. The cushion assembly of claim 27, wherein the first fastener comprises a shaft portion and a head portion opposite the retainer portion, the head portion comprising a larger dimension than the shaft portion such that the second fastener cooperates with the shaft portion to engage the first and second fasteners together.

29. The cushion assembly of claim 21, wherein the retainer portion of the first fastener and/or the second fastener has a cross-sectional area that is greater than a cross-sectional area of the protruding portion of the first fastener and/or the second fastener.

30. The cushion assembly of claim 21, wherein the fasteners comprise a thermoplastic polymer material.

31. The cushion assembly of claim 30, wherein the polymeric strands comprise the same thermoplastic polymer material.

32. A vehicle seat assembly comprising a frame supporting the cushion assembly of claim 21.

33. A cushion assembly comprising:
a first cushion comprising a first side defining a first surface and a first slot disposed below the first surface;
a first fastener comprising a retainer portion disposed in the first slot and a protruding portion protruding from the retainer portion through the first surface;
a second cushion; and
a second fastener configured to cooperate with the protruding portion, the second fastener being disposed in the second cushion such that the first and second cushions are coupled together when the first and second fasteners are coupled together.

34. The cushion assembly of claim 33, wherein the first and second cushions are coupled together without adhesive.

35. The cushion assembly of claim 33, wherein the second cushion comprises a second side defining a second surface, and a second slot disposed below the second surface, and the second fastener is disposed in the second slot.

36. The cushion assembly of claim 33, wherein the first cushion is a body of polymeric strands.

37. A method of coupling a cushion comprising:
disposing a first fastener in a first cushion defining a first surface portion, the first fastener comprising a first retainer portion and a protruding portion configured to extend through the first surface portion;
disposing a second fastener in a second cushion defining a second surface portion, the second fastener configured to be coupled to the first fastener and comprising a second retainer portion; and
coupling the first and second fasteners together such that the protruding portion extends through the first surface portion to the second fastener to couple the first and second cushions together.

38. The method of claim 37, wherein the first fastener is disposed in a first slot of the first cushion below the first surface portion of the first cushion and the second fastener is disposed in a second slot of the second cushion below the second surface portion of the second cushion.

39. The method of claim 38, further comprising defining the first slot in the first cushion and the second slot in the second cushion.
